(19) United States
(12) Patent Application Publication
(10) Pub. No.: US 2004/0050923 A1
(43) Pub. Date: Mar. 18, 2004

(54) Multifunctional card terminal

(76) Inventor: Thomas Reisser, Stuttgart (DE)

Correspondence Address: OSTROLENK FABER GERB & SOFFEN, 1180 AVENUE OF THE AMERICAS, NEW YORK, NY, 100368403

(21) Appl. No.: 10/415,116

(22) PCT Filed: Oct. 10, 2001
(86) PCT No.: PCT/DE01/03867

(30) Foreign Application Priority Data
Oct. 24, 2000 (DE) 100 52 813.9

(51) Int. Cl. G06F 17/00

(52) U.S. Cl. 235/375

(57) ABSTRACT

A card-reading device, including at least one card-reading unit, and at least one display unit for displaying information, the at least one display unit being operatively connected to the card-reading unit so as to display advertising information or the like when a card is inserted into or read by the card-reading unit.

The present invention relates to a card-reading device according to the preamble of Claim 1.

Card-reading devices or card terminals of the before-mentioned kind mostly serve to read out or write information from or on a card-like information carrier. As is generally known, such devices comprise a card-reading unit by means of which a card, for example a magnetic-strip card or a chip card or the like, can be inserted into the device for reading and—under certain circumstances—for recording.

In operation of such a card terminal it frequently happens that a queue of some length lines up in front of the device and that the waiting time of the persons so lining up is wasted without any use whatsoever.

Now, it is the object of the present invention to provide a card-reading device of the type described at the outset, which overcomes the before-mentioned disadvantages and allows people's waiting times to be used to the best possible effect.

This object is achieved by the features of the independent claims. Advantageous further developments are defined in the sub-claims. Especially, the invention proposes to solve the problem by an arrangement where the at least one display unit displays advertising information or the like when this action is initiated by the insertion or reading-in of a card.

It is the basic idea of the invention that the waiting times frequently occurring in front of card-reading devices of the described kind should be utilized for advertising measures by the use of an advertising vehicle additionally provided in the card-reading device, which can be activated by the insertion or reading-in of a card. The advertising effect can be further improved by selection of the largest possible display for advertising films or advertising spots, or exchangeable film posters that can easily be viewed by persons lining up in the queue. In order to further improve the visibility of the advertisements shown, the display unit is preferably provided, in addition to the compulsory card-reading unit, with a display unit that makes the most extensive use of the housing surface available.

When not in use, the display unit is, preferably, in a dormant state for energy-saving purposes. To effect transition into an operating mode, i.e. for activating the display unit, a switching element is preferably provided which coacts with a sensor system to detect the condition that a card is being inserted into the card-reading unit.

Further, it can be provided that the display unit displays new advertising information every time a card is inserted, or a particular advertising information if a card is inserted several times.

In an advantageous embodiment, the information displayed may also be of a personal kind.

According to another embodiment, the mounting height of the card-reading unit is such that a person can introduce the card into the card-reading unit without any effort.

As a rule, this mounting height is equal to approximately two thirds of the users' average height. In order to improve visibility of the display unit under the described conditions, the card-reading device comprises a housing with at least two sides that are bent off in downward direction one relative to the other. A bending angle in the range of 60 to 90 degrees, preferably about 75 degrees, guarantees that the display unit is still clearly visible for a person standing in front of the card-reading unit at the typical operating distance and/or a multiple of that distance.

According to a further embodiment, the two sides are formed from a continuous sheet of material that is bent off at the before-mentioned obtuse or acute angle at the point of transition between the two sides of the housing. This considerably simplifies the production of the housing of the unit.

In order to permit the use of a single card terminal in both directions of passage, it may be further provided that one display unit and one card-reading unit are arranged on each of the two sides.

Preferably, the display unit comprises an integrated flat display for the display of moving, especially visual or audio-visual information, and/or a holder for exchangeable film posters for static display of information in image form.

In addition, the arrangement may be such that the card terminal provides, in the area of transition between the two sides of the housing, a status display element and/or an additional display unit for display of status information regarding the respective operating status of the card-reading unit, or the like.

The card reader according to the invention can be used with advantage for admission checking and access control at company and stadium entrances, or the like, for example in the area of turnstiles, partition walls or entrance doors, and also in connection with automatic counters or automated teller machines, or the like.

It should be noted that the card terminal according to the invention is adapted to reading information from and writing information onto the card. Further, it is understood that the proposed card terminal is suited for reading in and reading out variable card formats, such as chip cards or magnetic-strip cards of the kind of credit cards, or admission tickets in paper strip format, or the like. Also, cards encoded in any desired way can be read in or read out.

In the detailed description of certain embodiments that follows identical or functionally similar features will be designated by the same reference numerals.

In the drawings

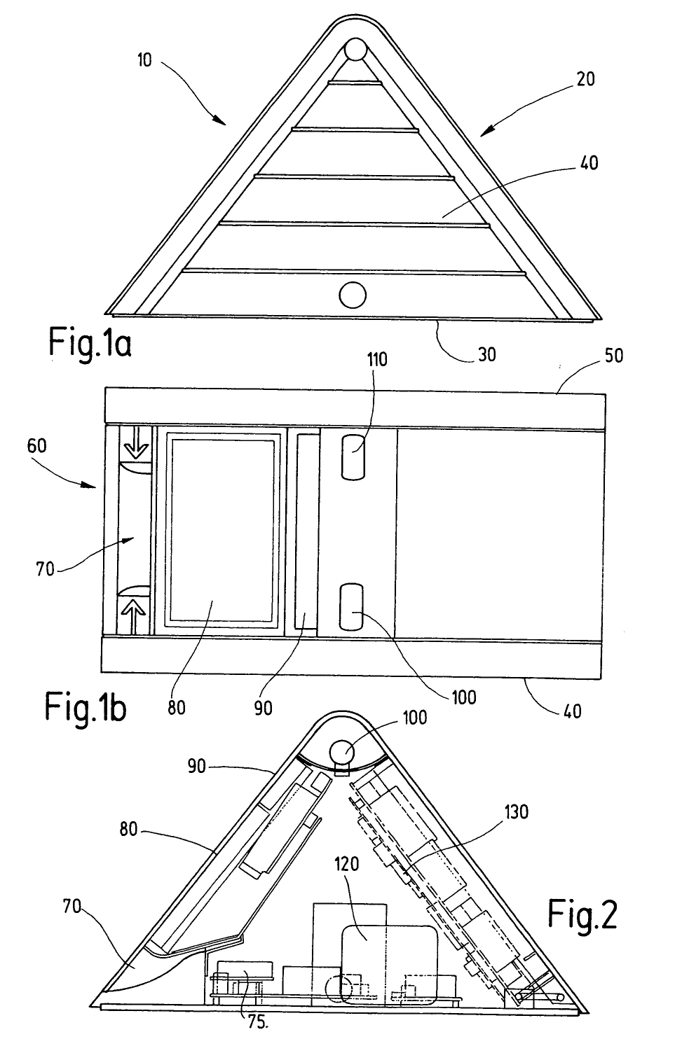

FIGS. 1a, b show an elevation and a top view, respectively, of one embodiment of the card-reading device according to the invention;

FIG. 2 shows a sectional elevation of the card-reading device illustrated in FIG. 1;

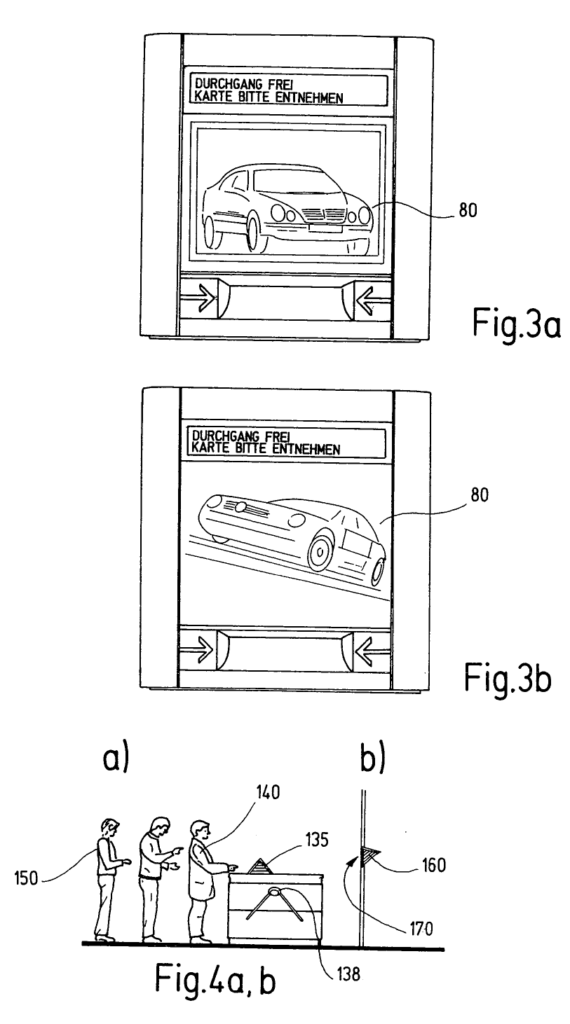

FIGS. 3a, b show front views of two embodiments of a display unit according to the invention; and

FIGS. 4a, b show two mounting examples for the card-reading device according to the invention.

The card-reading device, which is shown in the elevation of FIG. 1a, comprises two housing sides 10, 20 that are bent off one relative to the other, a base plate 30 and two lateral housing faces 40, 50, although only one of them can be seen in the drawing. The housing sides 10, 20 consist of a continuous, bent-off plexiglass plate having a thickness of 1 to 5 mm (preferably 3 mm), the angle between the two housing sides 10, 20 being 75 degrees in the illustrated embodiment. The entire upper part of the housing 10, 20, 40, 50 is mounted in pivoting arrangement so that the functional components located in the housing 10-50 are easily accessible for maintenance.

As can be seen in FIG. 2a, the card-reading unit 60 with the associated card slot 70 and two display units 80, 90 is provided only on the housing side 10 in the illustrated embodiment, while the rear side 20 is passive, i.e. does not comprise any of the before-mentioned functional units 60-90 in the illustrated example. However, it should be noted in this connection that the rear side 20 of the housing may of course also comprise a card-reading unit (not shown), a display unit 80 and, if desired, other functional units as described before, in order to permit the card terminal to be used in both passing directions, for example of a turnstile.

The relatively large display unit 80 comprises in the example a chromatic liquid crystal display (LCD) by means of which short advertising films or photos, or short photo sequences, can be displayed. In the illustrated example, the display unit 80 is, however, deactivated. It is understood that other flat display technologies, such as polymer displays (OLEDs), or the like, could be envisaged as well. Instead of using an LED display, it would however also be possible to use a backlight or frontlight unit for the static display of film posters, or the like.

The second display unit 90, which is arranged above the first display unit 80 and is considerably smaller or narrower, comprises in the illustrated example a monochromatic flat LCD for the display of status information on the card-reading unit. In the illustrated embodiment, the display unit 90 indicates that passage is free and that the card can be withdrawn by the respective user.

The components comprised in the device can be seen in the sectional elevation shown in FIG. 2 of the card terminal illustrated in FIGS. 1a, 1b, although the description that follows relates only to those components which are of importance for the present invention. A card pull-in mimic 75, that serves for automatically pulling in (and possibly also for thrusting out) the card and for reading out the information contained in the card, is provided in the area of the card-reading unit. Reading-out is effected either optically, electrically or by other data processing means not shown, using known techniques, depending on the particular type of the card. The card pull-in mimic 75 comprises a sensor system (not shown) that detects the condition that a card has been pulled in and supplies that information to a switch (not shown). The switch in its turn is connected to the two display units 80, 90, and will activate at least one of the two display units as soon as the condition that a card has been inserted or pulled in has been detected. Two signal lamps 100, 110 of different color (for example red and green) are arranged at the tip of the housing for indicating the card-reading status additionally by corresponding signals. This allows ergonomically clear signaling of the reading status of the card-reading unit. Further, a usual low-voltage supply 120 is arranged in the housing. The entire electronic control system required for the functions described above is accommodated on a board 130.

FIGS. 3a and 3b show front views of the two embodiments of the display unit 80 mentioned before. FIG. 3a shows a chromatic LCD by means of which short advertising spots can be displayed, while FIG. 3b shows a backlight unit by means of which film posters can be displayed, if desired, in rotation over time.

Finally, FIGS. 4a and 4b show two mounting examples for a card terminal 135, 160 according to the invention. The card-reading device 135 of example 4a has its base plate 30 mounted in the area of a turnstile 138. As a result of the described inclination of the upper housing surfaces 10, 20, the display unit 80 can be clearly seen by the person 140 and also by the person 150 still lining up in the queue so that a good advertising effect can be achieved with both persons 140, 150. In the illustration of FIG. 4b, the card-reading device 160 is mounted on a vertical partition wall and is accessible for its intended use from the side 170. It is apparent from the described embodiments that the card terminal according to the invention is suited for an extensive range of applications.

1. Card-reading device comprising at least one card-reading unit (60-75) and at least one display unit (80) for displaying information, characterized in that the at least one display unit (80) displays advertising information or the like when this action is initiated by the insertion or reading-in of a card.

2. The card-reading device as defined in claim 1, characterized by a switching or trigger element that activates the display unit (80) in response to the insertion or reading-in of a card.

3. The card-reading device as defined in claim 2, characterized by a sensor system, which is connected to the switching element and intended to detect the condition that a card has been introduced into the card-reading unit (60-75).

4. The card-reading device as defined in any of the preceding claims, characterized in that the display unit (80) displays new advertising information every time a card is inserted, or a particular advertising information when a card is inserted several times.

5. The card-reading device as defined in any of the preceding claims, characterized in that when a card is inserted the display unit (80) displays personal information stored in the card and/or data selected in response to personal information.

6. The card-reading device as defined in any of the preceding claims, characterized by a housing comprising at least two sides (10, 20) bent off in downward direction one relative to the other.

7. The card-reading device as defined in claim 6, characterized in that the angle is in the range of 60 to 90 degrees, preferably equal to approximately 75 degrees.

8. The card-reading device as defined in claim 6 or claim 7, characterized in that the two sides (10, 20) are formed from a continuous sheet of material, especially from plexiglass, having a thickness in the range of 1 to 5 mm, which is bent off in the transition area between the two sides at an obtuse or an acute angle.

9. The card-reading device as defined in any of claims 6 to 8, characterized in that a display unit (80) and a card-reading unit (60-75) are arranged on each of the two sides (10, 20).

10. The card-reading device as defined in any of the preceding claims, characterized in that the at least one display unit (80) comprises an integrated flat display for the display of moving information, and/or a backlight or a frontlight unit for exchangeable film posters, for static display of information.

11. The card-reading device as defined in any of claims 6 to 10, characterized by a status display element (100, 110) arranged in the area of transition between the two sides and/or at least a third display unit (90) for the display of status information.
